(19) United States
(12) Patent Application Publication
(10) Pub. No.: US 2004/0054113 A1
(43) Pub. Date: Mar. 18, 2004

(54) Polymers with soft segments containing silane-containing groups, medical devices, and methods

(75) Inventors: Michael E. Benz, Ramsey, MN (US); Christopher M. Hobot, Tonka Bay, MN (US); Kelvin Bonnema, Brooklyn Park, MN (US); Randall V. Sparer, Andover, MN (US)

Correspondence Address: MUETING, RAASCH & GEBHARDT, P.A., P.O. BOX 581415, MINNEAPOLIS, MN, 55458, US

(73) Assignee: Medtronic, Inc., Minneapolis, MN

(21) Appl. No.: 10/663,925

(22) Filed: Sep. 16, 2003

Related U.S. Application Data
(60) Provisional application No. 60/459,299, filed on Apr. 1, 2003.
(60) Provisional application No. 60/411,818, filed on Sep. 17, 2002.

(51) Int. Cl. C08G 77/00

(52) U.S. Cl. 528/10; 528/44

(57) ABSTRACT

Polymers that include silane-containing groups in soft segments, and optionally urethane groups, as well as medical devices and methods for making such compounds.

### CROSS REFERENCE TO RELATED APPLICATIONS

This application claims priority to U.S. Provisional Application No. 60/411,818, filed on Sep. 17, 2002, and U.S. Provisional Application No. 60/459,299, filed on Apr. 1, 2003, which are incorporated herein by reference in their entireties.

### FIELD OF THE INVENTION

This invention relates to polymers with silane-containing soft segments, preferably such compounds are polymers containing urethane groups, particularly elastomers. Such materials are particularly useful as biomaterials in medical devices.

### BACKGROUND OF THE INVENTION

The chemistry of polyurethanes and/or polyureas is extensive and well developed. Typically, polyurethanes and/or polyureas are made by a process in which a polyisocyanate is reacted with a molecule having at least two functional groups reactive with the polyisocyanate, such as a polyol or polyamine. The resulting polymer can be further reacted with a chain extender, such as a diol or diamine, for example. The polyol or polyamine is typically a polyester, polyether, or polycarbonate polyol or polyamine, for example.

Polyurethanes and/or polyureas can be tailored to produce a range of products from soft and flexible to hard and rigid. They can be extruded, injection molded, compression molded, and solution spun, for example. Thus, polyurethanes and polyureas, particularly polyurethanes, are important biomedical polymers, and are used in implantable devices such as artificial hearts, cardiovascular catheters, pacemaker lead insulation, etc.

Commercially available polyurethanes used for implantable applications include BIOSPAN segmented polyurethanes, manufactured by Polymer Technology Group of Berkeley, Calif., PELLETHANE segmented polyurethanes, sold by Dow Chemical, Midland, Mich., and TECOFLEX segmented polyurethanes sold by Thermedics Polymer Products, Wilmington, Mass. Polyurethanes are described in the article “Biomedical Uses of Polyurethanes,” by Coury et al., in Advances in Urethane Science and Technology, 9, 130-168, edited by Kurt C. Frisch and Daniel Klempner, Technomic Publishing Co., Lancaster, Pa. (1984). Typically, polyether polyurethanes exhibit more biostability than polyester polyurethanes and polycarbonate polyurethanes, as these are more susceptible to hydrolysis. Thus, polyether polyurethanes are generally preferred biopolymers.

Polyether polyurethane elastomers, such as PELLETHANE 2363-80A (P80A) and 2363-55D (P55D), which are prepared from polytetramethylene ether glycol (PTMEG) and methylene bis(diisocyanatobenzene) (MDI) extended with 1,4-butanediol (BDO), are widely used for implantable cardiac pacing leads. Pacing leads are electrodes that carry stimuli to tissues and biologic signals back to implanted pulse generators. The use of polyether polyurethane elastomers as insulation on such leads has provided significant advantage over silicone rubber, primarily because of the higher tensile strength of the polyurethanes.

There is some problem, however, with biodegradation of polyether polyurethane insulation, which can cause failure. Polyether polyurethanes are susceptible to oxidation in the body, particularly in areas that are under stress. When oxidized, polyether polyurethane elastomers can lose strength and can form cracks, which might eventually breach the insulation. This, thereby, can allow bodily fluids to enter the lead and form a short between the lead wire and the implantable pulse generator (IPG). It is believed that the ether linkages degrade, perhaps due to metal ion catalyzed oxidative attack at stress points in the material.

One approach to solving this problem has been to coat the conductive wire of the lead. Another approach has been to add an antioxidant to the polyurethane. Yet another approach has been to develop new polyurethanes that are more resistant to oxidative attack. Such polyurethanes include only segments that are resistant to metal induced oxidation, such as hydrocarbon- and carbonate-containing segments. For example, polyurethanes that are substantially free of ether and ester linkages have been developed. This includes the segmented aliphatic polyurethanes of U.S. Pat. No. 4,873,308 (Coury et al.). Another approach has been to include a sacrificial moiety (preferably in the polymer backbone) that preferentially oxidizes relative to all other moieties in the polymer, which upon oxidation provides increased tensile strength relative to the polymer prior to oxidation. This is disclosed in U.S. Pat. Nos. 5,986,034 (DiDomenico et al.), 6,111,052 (DiDomenico et al.), and 6,149,678 (DiDomenico et al.).

Although such materials produce more stable implantable devices than polyether polyurethanes, there is still a need for biostable polymers, particularly polyurethanes suitable for use as insulation on pacing leads.

### SUMMARY OF THE INVENTION

The present invention relates to polymers that include silane-containing soft segments. Particularly preferred polymers include those containing urethane groups, urea groups, or combinations thereof (i.e., polyurethanes, polyureas, or polyurethane-ureas). Preferably, the polymer is a segmented polyurethane. Certain embodiments of the polymers of the present invention can be used as biomaterials in medical devices. Certain embodiments of the polymers are substantially free of carbonate linkages and/or urea linkages. Preferred polymers are also preferably substantially free of ester and ether linkages.

The present invention also provides a polymer, and a medical device that incorporates such polymer, wherein the polymer includes one or more soft segments that include a silane-containing group, wherein the soft segments are prepared from a compound (typically a polymeric starting compound) of the formula (Formula I):

HO—R¹—Si(R²)₂—[—R³—Si(R²)₂—]ₙ—R¹—OH

wherein: n=1 or more; each R¹ is independently a straight chain or branched alkylene group (typically referred to as a divalent saturated aliphatic group) optionally including heteroatoms; each R² is independently a saturated or unsaturated aliphatic group, an aromatic group, or combinations thereof, optionally including heteroatoms (typically referred to as a monovalent group); and each R³ is independently a straight chain alkylene group, a phenylene group, or a straight chain or branched alkyl substituted phenylene group, wherein each R³ optionally includes heteroatoms (typically referred to as a divalent group).

Accordingly, the polymer of the present invention includes soft segments that include groups of the formula (Formula II):

—R¹—Si(R²)₂—[—R³—Si(R²)₂—]ₙ—R¹—

wherein n, R¹, R², and R³ are as described above.

Preferably, the polymer is substantially free of carbonate and urea linkages. More preferably, the polymer includes urethane linkages (i.e., groups).

It should be understood that in the above formulas, each of the moieties —R³—Si(R²)₂— can vary within any one molecule. That is, in addition to each of the R² groups being the same or different (i.e., independently) within each Si(R²)₂ group, each of the —R³—Si(R²)₂— groups can be the same or different in any one molecule.

Methods of preparation of such polymers are also provided. In one method, a segmented polymer is prepared by combining a polyisocyanate with a compound of the formula:

HO—R¹—Si(R²)₂—[—R³—Si(R²)₂—]ₙ—R¹—OH

wherein: n=1 or more; each R¹ is independently an alkylene group optionally including heteroatoms; each R² is independently a saturated or unsaturated aliphatic group, an aromatic group, or combinations thereof, optionally including heteroatoms; and each R³ is independently an alkylene group, a phenylene group, or a straight chain or branched alkyl substituted phenylene group, wherein each R³ optionally includes heeroatoms; with the proviso that the polymer is substantially free of carbonate linkages.

As used herein, the terms “a,” “an,” “one or more,” and “at least one” are used interchangeably.

As used herein, the term “aliphatic group” means a saturated or unsaturated linear (i.e., straight chain), cyclic (i.e., cycloaliphatic), or branched organic hydrocarbon group. This term is used to encompass alkyl (e.g., —CH₃, which is considered a “monovalent” group) (or alkylene if within a chain such as —CH₂—, which is considered a “divalent” group), alkenyl (or alkenylene if within a chain), and alkynyl (or alkynylene if within a chain) groups, for example. The term “alkyl group” means a saturated linear or branched hydrocarbon group including, for example, methyl, ethyl, isopropyl, t-butyl, heptyl, dodecyl, octadecyl, amyl, 2-ethylhexyl, and the like. The term “alkenyl group” means an unsaturated, linear or branched hydrocarbon group with one or more carbon-carbon double bonds, such as a vinyl group. The term “alkynyl group” means an unsaturated, linear or branched hydrocarbon group with one or more carbon-carbon triple bonds. The term “aromatic group” or “aryl group” means a mono- or polycyclic aromatic organic hydrocarbon group. These hydrocarbon groups may be substituted with heteroatoms, which can be in the form of functional groups. The term “heteroatom” means an element other than carbon (e.g., nitrogen, oxygen, sulfur, chlorine, etc.). A group that may be the same or different is referred to as being “independently” something.

As used herein, a “biomaterial” may be defined as a material that is substantially insoluble in body fluids and tissues and that is designed and constructed to be placed in or onto the body or to contact fluid or tissue of the body. Ideally, a biomaterial will not induce undesirable reactions in the body such as blood clotting, tissue death, tumor formation, allergic reaction, foreign body reaction (rejection) or inflammatory reaction; will have the physical properties such as strength, elasticity, permeability and flexibility required to function for the intended purpose; can be purified, fabricated and sterilized easily; and will substantially maintain its physical properties and function during the time that it remains implanted in or in contact with the body. A “biostable” material is one that is not broken down by the body, whereas a “biocompatible” material is one that is not rejected by the body.

As used herein, a “medical device” may be defined as a device that has surfaces that contact blood or other bodily tissues in the course of their operation. This can include, for example, extracorporeal devices for use in surgery such as blood oxygenators, blood pumps, blood sensors, tubing used to carry blood and the like which contact blood which is then returned to the patient. This can also include implantable devices such as vascular grafts, stents, electrical stimulation leads, heart valves, orthopedic devices, catheters, shunts, sensors, replacement devices for nucleus pulposus, cochlear or middle ear implants, intraocular lenses, and the like.

### DETAILED DESCRIPTION OF ILLUSTRATIVE EMBODIMENTS OF THE INVENTION

The present invention provides polymers (preferably, segmented polymers, and more preferably segmented polyurethanes), and medical devices that include such polymers (preferably, biomaterials). Preferably, the polymers are generally resistant to oxidation and/or hydrolysis, particularly with respect to their backbones, as opposed to their side chains.

The polymers include one or more silane groups in one or more soft segments. These silane groups are of the general formula —Si(R²)₂— wherein each R² is independently (i.e., may be the same or different) a saturated or unsaturated aliphatic group, an aromatic group, or combinations thereof, optionally including heteroatoms (which may be in the chain of the organic group or pendant therefrom as in a functional group).

The polymers also include R³ groups bonded to the silane group, thereby forming an —R³—Si(R²)₂— moiety (preferably a repeat unit). Each R³ is independently a straight or branched chain alkylene group (typically referred to as a divalent aliphatic group, such as —CH₂—CH₂—, and the like), a phenylene, or a straight chain or branched alkyl substituted phenylene, optionally including heteroatoms.

Polymers of the present invention are prepared from a compound of the formula (Formula I):

HO—R¹—Si(R²)₂—[—R³—Si(R²)₂—]ₙ—R¹ —OH

wherein: n=1 or more; R² and R³ are as defined above, and each R¹ is independently a straight chain or branched alkylene group (typically referred to as a divalent saturated aliphatic group) optionally including heteroatoms. Preferably, the polymer is substantially free of carbonate linkages.

More specifically, soft segments of a segmented polymer, particularly a polymer containing urethane and/or urea groups, and more particularly a polymer containing urethane groups, are derived from a compound of Formula I, thereby resulting in polymers with silane-containing soft segments that include groups of the following formula (Formula II):

—R¹—Si(R²)₂—[—R³—Si(R²)₂—]ₙ—R¹—

wherein n, R¹, R², and R³ are as defined above.

The present invention provides advantage in terms of the synthesis and properties of the resultant polymer relative to polymers derived from silane-containing chain extenders, which form hard segments, as described in International Publication No. WO 99/03863. In this latter method, the silane-containing chain extenders in the hard segment improve the compatibility between hard segments and soft segments, which improves the strength of the polymer. In the present invention, silane-containing compounds of Formula I are used in the soft segment to provide such compatibility. These polymers have improved strength using commercially available chain extenders compared to those described in WO 99/03863. Furthermore, it is believed that the properties of the polymers of the present invention are more easily controllable than that of the polymers of WO 99/03863 because the structures of the soft segments are more easily variable using the compounds of Formula I.

Polymers of the present invention can be used in medical devices as well as nonmedical devices. Preferably, they are used in medical devices and are suitable as biomaterials. Examples of medical devices are listed above. Examples of nonmedical devices include foams, insulation, clothing, footwear, paints, coatings, adhesives, building construction materials, etc.

The polymers suitable for forming biomaterials for use in medical devices according to the present invention include silane-containing groups (i.e., silane-containing moieties or simply silane groups or moieties), and are preferably polyurethanes, polyureas, or polyurethane-ureas. More preferably they are polyurethanes. These polymers can vary from hard and rigid to soft and flexible. Preferably, the polymers are elastomers. An “elastomer” is a polymer that is capable of being stretched to approximately twice its original length and retracting to approximately its original length upon release.

Polymers of the present invention are segmented copolymers (i.e., containing a multiplicity of both hard and soft domains or segments on any polymer chain) and are comprised substantially of alternating relatively soft segments and relatively hard segments. At least one of the soft segments includes a silane-containing moiety, thereby providing a polymer that has reduced susceptibility to oxidation and/or hydrolysis, at least with respect to the polymer backbone. One or more hard segments can also include a silane-containing moiety. As used herein, a “hard” segment is one that is either crystalline at use temperature or amorphous with a glass transition temperature above use temperature (i.e., glassy), and a “soft” segment is one that is amorphous with a glass transition temperature below use temperature (i.e., rubbery). A crystalline or glassy moiety or hard segment is one that adds considerable strength and higher modulus to the polymer. Similarly, a rubbery moiety or soft segment is one that adds flexibility and lower modulus, but may add strength particularly if it undergoes strain crystallization, for example. The random or alternating soft and hard segments are linked by urethane and/or urea groups (preferably urethane groups) and the polymers may be terminated by hydroxyl or amine groups, (preferably hydroxyl groups) and/or isocyanate groups.

As used herein, a “crystalline” material or segment is one that has ordered domains. A “noncrystalline” material or segment is one that is amorphous (a noncrystalline material may be glassy or rubbery). A “strain crystallizing” material is one that forms ordered domains when a strain or mechanical force is applied.

An example of a medical device for which the polymers are particularly well suited includes a medical electrical lead, such as a cardiac pacing lead, a neurostimulation lead, etc. Examples of such leads are disclosed, for example, in U.S. Pat. Nos. 5,040,544 (Lessar et al.), 5,375,609 (Molacek et al.), 5,480,421 (Otten), and 5,238,006 (Markowitz).

Polymers and Methods of Preparation

A wide variety of segmented copolymers are provided by the present invention. Preferably, they are copolymers (including terpolymers, tetrapolymers) that include silane-containing groups as described herein. They can also include olefins, amides, esters, imides, epoxies, ureas, urethanes, carbonates, sulfones, ethers, acetals, phosphonates, and the like. More preferably, they are substantially free of one or more of the following: ureas, carbonates, esters, and ethers. Such polymers can be prepared using a variety of techniques from polymerizable compounds (e.g., monomers, oligomers, or polymers) containing silane groups. Such compounds include dienes, diols, diamines, or combinations thereof, for example. The soft segments with the silane-containing groups are derived from compounds of Formula I, and thereby include compounds of Formula II.

Although certain preferred polymers are described herein, the polymers used to form the preferred biomaterials in the medical devices of the present invention can be a wide variety of polymers that include urethane groups, urea groups, or combinations thereof. Such polymers are prepared from isocyanate-containing compounds, such as polyisocyanates (preferably diisocyanates) and compounds having at least two functional groups reactive with the isocyanate groups, such as polyols and/or polyamines (preferably diols and/or diamines). Any of these reactants can include a silane moiety (preferably in the polymer backbone), although preferably a silane moiety is provided by the diols of Formula I. Thus, preferably, the polymers are polyurethanes.

The presence of the silane-containing moiety provides a polymer that is typically more resistant to oxidative and/or hydrolytic degradation but still has a low Tg. Furthermore, preferably, both the hard and soft segments are themselves substantially ether-free, ester-free, and carbonate-free polyurethanes, polyureas, or combinations thereof. Preferably, the polymer of the present invention is a polyurethane (and substantially free of urea linkages).

Preferred polymers of the present invention include one or more urethane groups, urea groups, or combinations thereof (preferably, just urethane groups). In another embodiment, particularly preferred polymers are copolymers (i.e., prepared from two or more monomers, including terpolymers or tetrapolymers). Thus, the present invention provides polymers with the silane groups distributed in segments.

Polymers of the present invention can be linear, branched, or crosslinked. This can be done using polyfunctional isocyanates or polyols (e.g., diols, triols, etc.) or using compounds having unsaturation or other functional groups (e.g., thiols) in one or more monomers with radiation crosslinking. Such methods are well known to those of skill in the art.

Preferably, such polymers (and the compounds used to make them) have substantially no tertiary carbons in the main chain (i.e., backbone).

As stated above, polymers of the present invention are prepared from a compound of the formula (Formula I):

HO—R¹—Si(R²)₂—[—R³—Si(R²)₂—]ₙ—R¹—OH

wherein: n=1 or more; R² and R³ are as defined above, and each R¹ is independently a straight chain or branched alkylene group optionally including heteroatoms. Preferably, the polymer is substantially free of carbonate linkages and/or urea linkages.

It should be understood that in the above formulas, each of the moieties —R³—Si(R²)₂— can vary within any one molecule. That is, in addition to each of the R² groups being the same or different within each Si(R²)₂ group, each of the —R³—Si(R²)₂— groups can be the same or different in any one molecule. The value for “n” is an average value. Preferably, n is 1 to 50, and more preferably, n is 1 to 20.

The R¹, R², and R³groups are selected such that the number average molecular weight of a polymeric starting material of the present invention is preferably no greater than about 100,000 grams per mole (g/mol or Daltons), more preferably, no greater than about 5000 g/mol, and most preferably no greater than about 1500 g/mol. Preferably, the number average molecular weight of the polymeric starting material is at least about 500 g/mol.

The number average molecular weight of the resultant polymer (without crosslinking) of the present invention is preferably no greater than about 100,000,000 g/mol, which is desirable for melt processing of the polymer. More preferably, the number average molecular weight of the resultant polymer (without crosslinking) of the present invention is no greater than about 500,000 g/mol. Preferably, the number average molecular weight of the polymer (without crosslinking) is at least about 20,000 g/mol.

In this compound (and the resultant polymer), preferably, each R¹ is independently a straight chain or branched alkylene group. More preferably, they include up to 20 carbon atoms, and most preferably from 3 to 20 carbon atoms.

Each R¹ is independently a straight chain or branched alkylene group optionally including heteroatoms, such as nitrogen, oxygen, phosphorus, sulfur, and halogen. The heteroatoms can be in the backbone of the polymer or pendant therefrom, and they can form functional groups (e.g., carbonyl). Preferably, R¹ does not include heteroatoms. More preferably, each R¹ is independently a straight chain or branched alkylene group including 20 carbon atoms or less. Most preferably, each R¹ is independently a straight chain or branched (C3-C20)alkylene group.

The R² groups of the compound of Formula I (and the resultant polymer) on the silicon atoms are selected such that the ultimate product (e.g., a segmented polyurethane polymer) have the following properties relative to a polymer without the silane groups: greater chain flexibility; less susceptibility to oxidation and hydrolysis; and/or greater ability to modify the polymers using functional groups within the R groups.

Although the silane groups reduce the susceptibility of the polymeric starting material and the ultimate polymer to oxidation or hydrolysis, the R² groups could themselves be susceptible to oxidation or hydrolysis as long as the main chain (i.e., the backbone) is not generally susceptible to such reactions.

Preferably, the R² groups are each independently an alkyl group, an aryl group, or combinations thereof. More preferably, each R² is independently an alkyl group, a phenyl group, or an alkyl substituted phenyl group. Even more preferably, each R² is independently a straight chain or branched alkyl group (preferably having 20 carbon atoms or less), a phenyl group, or a straight chain or branched alkyl substituted phenyl group (preferably having 20 carbon atoms or less, and more preferably 6 carbon atoms or less, in the alkyl substituent). Most preferably, the R² groups are each independently a straight chain or branched (C1-C3)alkyl group (preferably without heteroatoms).

Optionally, the R² groups can include heteroatoms, such as nitrogen, oxygen, phosphorus, sulfur, and halogen. These could be in the chain of the organic group or pendant therefrom in the form of functional groups, as long as the polymer is generally resistant to oxidation and/or hydrolysis, particularly with respect to its backbone, as opposed to its side chains. Such heteroatom-containing groups (e.g., functional groups) include, for example, an alcohol, ether, acetoxy, ester, aldehyde, acrylate, amine, amide, imine, imide, nitrile, whether they be protected or unprotected.

Each R³ is independently a straight chain alkylene group, a phenylene group, or a straight chain or branched alkyl substituted phenylene group, wherein each R³ optionally includes heteroatoms. Preferably, each R³ is independently a straight chain alkylene group. Preferably, R³ does not include heteroatoms. More preferably, each R³ includes 20 carbon atoms or less, even more preferably 12 carbon atoms or less, and most preferably 10 carbon atoms or less. More preferably, each R³ includes at least 1 carbon atom, more preferably, at least 4 carbon atoms, and most preferably at least 6 carbon atoms. Alternatively, each alkyl substituent on the phenylene group independently and preferably includes 20 carbon atoms or less, even more preferably 12 carbon atoms or less, and most preferably 10 carbon atoms or less. More preferably, each alkyl substituent on the phenylene group independently and preferably includes at least 1 carbon atom, more preferably, at least 4 carbon atoms, and most preferably at least 6 carbon atoms. For certain embodiments, such as when R³ is an unsubstituted straight chain alkylene group, it has more than 4 carbon atoms.

The polymers of the present invention can be prepared using standard techniques. Certain polymers can be made using one or more of the compounds of Formula I.

One could react the hydroxyl groups of the starting material of Formula I with di-, tri-, or poly(acids), di-, tri-, or poly(acyl chlorides), or with cyclic esters (lactones) to form poly(esters). Alternatively, one could react those hydroxyl groups with vinyl ether-containing compounds to make poly(acetals). Alternatively, one could react those hydroxyls with sodium hydroxide to form sodium salts, and further react those salts with phosgene to form poly(carbonates). Reacting those sodium salts with other alkyl halide containing moieties can lead to poly(sulfones), poly(phosphates), and poly(phosphonates).

Typically, the preferred urethane-containing polymers are made using polyisocyanates and one or more compounds of Formula I. It should be understood, however, that diols that do not contain such silane-containing moieties can also be used to prepare the polymers (e.g., soft segments of the polymers) of the present invention, as long as the resultant polymer includes at least some silane-containing moieties from the diols of Formula I. Also, other polyols and/or polyamines can be used, including polyester, polyether, and polycarbonate polyols, for example, although such polyols are less preferred because they produce less biostable materials. Furthermore, the polyols and polyamines can be aliphatic (including cycloaliphatic) or aromatic, including heterocyclic, or combinations thereof.

Examples of suitable polyols (typically diols) include those commercially available under the trade designation POLYMEG and other polyethers such as polyethylene glycol and polypropylene oxide, polybutadiene diol, dimer diol (e.g., that commercially available under the trade designation DIMEROL (from Unichema North America, Chicago, Ill.), polyester-based diols such as those commercially available as STEPANPOL (from Stepan Corp., Northfield, Ill.), CAPA (a polycaprolactone diol from Solvay, Warrington, Cheshire, United Kingdom), TERATE (from Kosa, Houston, Tex.), poly(ethylene adipate) diol, poly(ethylene succinate) diol, poly(1,4-butanediol adipate) diol, poly(caprolactone) diol, poly(hexamethylene phthalate) diol, and poly(1,6-hexamethylene adipate) diol, as well as polycarbonate-based diols such as poly(hexamethylene carbonate) diol.

Other polyols can be used as chain extenders in the preparation of polymers, as is conventionally done in preparation of polyurethanes, for example. Chain extenders are used to provide hard segments. Examples of suitable chain extenders include 1,10-decanediol, 1,12-dodecanediol, 9-hydroxymethyl octadecanol, cyclohexane-1,4-diol, cyclohexane-1,4-bis(methanol), cyclohexane-1,2-bis(methanol), ethylene glycol, diethylene glycol, 1,3-propylene glycol, dipropylene glycol, 1,2-propylene glycol, trimethylene glycol, 1,2-butylene glycol, 1,3-butanediol, 2,3-butanediol, 1,4-butanediol, 1,5-pentanediol, 1,6-hexanediol, 1,2-hexylene glycol, 1,2-cyclohexanediol, 2-butene-1,4-diol, 1,4-cyclohexanedimethanol, 2,4-dimethyl-2,4-pentanediol, 2-methyl-2,4-pentanediol, 1,2,4-butanetriol, 2-ethyl-2-(hydroxymethyl)-1,3-propanediol, glycerol, 2-(hydroxymethyl)-1,3-propanediol, neopentyl glycol, pentaerythritol, and the like. Other chain extenders are described in International Publication No. WO 99/03863.

Examples of suitable polyamines (typically diamines) include ethylenediamine, 1,4-diaminobutane, 1,10-diaminodecane, 1,12-diaminododecane, 1,8-diaminooctane, 1,2-diaminopropane, 1,3-diaminopropane, tris(2-aminoethyl)amine, lysine ethyl ester, and the like.

Examples of suitable mixed alcohols/amines include 5-amino-1-pentanol, 6-amino-1-hexanol, 4-amino-1-butanol, 4-aminophenethyl alcohol, ethanolamine, and the like.

Suitable isocyanate-containing compounds for preparation of polyurethanes, polyureas, or polyurethanes-ureas, are typically aliphatic, cycloaliphatic, aromatic, and heterocyclic (or combinations thereof) polyisocyanates. In addition to the isocyanate groups they can include other functional groups such as biuret, urea, allophanate, uretidine dione (i.e., isocyanate dimer), and isocyanurate, etc., that are typically used in biomaterials. Suitable examples of polyisocyanates include 4,4′-diisocyanatodiphenyl methane (MDI), 4,4′-diisocyanatodicyclohexyl methane (HMDI), cyclohexane-1,4-diisocyanate, cyclohexane-1,2-diisocyanate, isophorone diisocyanate, tolylene diisocyanates, naphthylene diisocyanates, benzene-1,4-diisocyanate, xylene diisocyanates, trans-1,4-cyclohexylene diisocyanate, 1,4-diisocyanatobutane, 1,12-diisocyanatododecane, 1,6-diisocyanatohexane, 1,5-diisocyanato-2-methylpentane, 4,4′-methylenebis(cyclohexyl isocyanate), 4,4′-methylenebis(2,6-diethyphenyl isocyanate), 4,4′-methylenebis(phenyl isocyanate), 1,3-phenylene diisocyanate, poly((phenyl isocyanate)-co-formaldehyde), tolylene-2,4-diisocyanate, tolylene-2,6-diisocyanate, dimer diisocyanate, as well as polyisocyanates available under the trade designations DESMODUR RC, DESMODUR RE, DESMODUR RFE, and DESMODUR RN from Bayer, and the like.

The relatively hard segments of the polymers of the present invention are preferably fabricated from short to medium chain diisocyanates and short to medium chain diols or diamines, all of which preferably have molecular weights of less than about 1000 grams/mole. Appropriate short to medium chain diols, diamines, and diisocyanates include straight chain, branched, and cyclic aliphatics, although aromatics can also be used. Examples of diols and diamines useful in these more rigid segments include both the short and medium chain diols or diamines discussed above.

In addition to the polymers described herein, biomaterials of the invention can also include a variety of additives. These include, antioxidants, colorants, processing lubricants, stabilizers, imaging enhancers, fillers, and the like.

Starting Materials and Methods of Preparation

The compounds of Formula I above can be made by the synthetic route described in the Examples Section. This typically involves either an ADMET (acyclic diene metathesis) polymerization route or a hydrosilylation route or a combination thereof.

In a typical ADMET method for the preparation of a silane-containing diol, a silane-containing diene monomer and an alkene compound containing a protected alcohol, and optionally other diene monomers, are combined in the presence of a suitable metathesis polymerization catalyst. This initial product is subsequently deprotected and hydrogenated to yield the desired silane-containing diol.

In a typical hydrosilylation method for the preparation of a silane-containing diol, a disilane and an vinyl-containing compound with a protected alcohol, and optionally a divinyl compound, are polymerized in the presence of a hydrosilylation catalyst. After polymerization, the alcohols are deprotected to yield the desired silane-containing diol.

Such methods are exemplary only. The present invention is not limited by the methods of making the compounds of Formula I or the polymers derived from the compounds of Formula I.

The invention has been described with reference to various specific and preferred embodiments and will be further described by reference to the following detailed examples. It is understood, however, that there are many extensions, variations, and modification on the basic theme of the present invention beyond that shown in the examples and detailed description, which are within the spirit and scope of the present invention.

### EXAMPLES

All glassware was dried prior to use. The 1,10-dibromodecane was purchased from Fluka (Milwaukee, Wis.). The falling film evaporator was purchased from Aldrich Chemical Company, Incorporated (Milwaukee, Wis.). Magnesium turnings, anhydrous tetrahydrofuran, chlorodimethylsilane, hexane, hexamethyldisilazane, trimethyl chlorosilane, dodecane, xylenes, anhydrous dimethylacetamide, dibutyltin dilaurate, 1,5-hexadiene, diethylsilane, hexanes, sodium hydroxide, AMBERLITE IRC-718 ion exchange resin, ALIQUOT 336, magnesium sulfate, sodium bicarbonate, 3,4-dihydro-2H-pyran, potassium carbonate, 1,6-dichlorohexane, anhydrous dioxane, methylene chloride, silica gel, activated neutral alumina, p-toluenesulfonic acid monohydrate, diethylsilane, diphenylsilane, reagent grade ethanol, toluene, and 10% palladium on activated carbon are all available from Aldrich. Prior to use, the AMBERLITE IRC-718 ion exchange resin beads are dried using a rotary evaporator.

Tricyclohexylphosphine[1,3-bis(2,4,6-trimethylphenyl)-4,5-dihydroimidazol-2-ylidene][benzylidine]ruthenium(IV) dichloride (Grubbs' imidazolium ruthenium metathesis catalyst) was purchased from Strem Chemicals Inc., Newburyport, Mass, and stored at −30° C. in an argon atmosphere glovebox until used. The temperatures reported for metathesis reactions were measured using a thermocouple placed between the flask and the heating mantle.

### Example 1

Synthesis of 1,10-Bis(dimethysilyl)decane

A three-liter three-neck round-bottomed flask was outfitted with a mechanical stirrer, thermocouple, and two-liter addition funnel. A nitrogen line connected to a bubbler was attached to the top of the addition funnel. Eighty-five grams of magnesium turnings were placed in the flask. Then 1,10-dibromodecane was added to the addition funnel. Then dry tetrahydrofuran (Aldrich anhydrous grade) was added to the addition funnel to fill it. About fifty milliliters of this solution was added to the magnesium turnings and the resulting mixture was stirred. After the reaction initiated, as evidenced by the mixture turning cloudy, the remaining solution was added dropwise at a rate such that the exotherm did not exceed the boiling point of tetrahydrofuran. The funnel was rinsed with an additional aliquot of tetrahydrofuran after the addition was complete. A condenser then replaced the addition funnel and the reaction mixture was heated to reflux. The reaction mixture was refluxed for two hours and cooled to room temperature. The funnel was then put back on the reaction flask in place of the condenser, and 325 grams chlorodimethylsilane was added dropwise at a rate that maintained the temperature of the reaction mixture below the boiling point of the silane. The reaction mixture was then stirred at room temperature overnight. A minimal amount of water was then added cautiously to quench any remaining Grignard reagent and the mixture was vacuum filtered using a Buechner funnel to remove the precipitated magnesium salts. The salts were washed with several small portions of hexane and the hexane was added to the filtrate. The solvents were removed under vacuum using a rotary evaporator. The crude product was then distilled under vacuum through a 20-centimeter (cm) Vigreux column. Several fractions were taken, and the fraction distilling at about 0.32 Pascal (Pa, 2.4 millitorr) and 104-118° C. contained the bulk of the product. There were 276.8 grams in this fraction, and the identity and purity of the product was confirmed using gas chromatography, infrared spectroscopy, and nuclear magnetic resonance spectroscopy.

### Example 2

Synthesis of Trimethylsilyl-protected 10-Undecen-1-ol

The 10-undecen-1-ol was placed in a round-bottomed flask equipped with a magnetic stirbar. An addition funnel containing 0.5 equivalent of hexamethyldisilazane was attached to the flask. Ten drops trimethylchlorosilane was added to the flask, and stirring was initiated. The hexamethyldisilizane was added dropwise. The nitrogen evolved by reaction was used to monitor its progress. When the reaction was complete, the crude product was distilled under vacuum, yielding the desired product.

### Example 3

Synthesis of the Disilane Diol 1

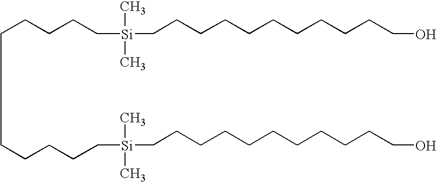

Structure of the disilane diol 1.

In a one-liter three-neck round-bottomed flask outfitted with a stirbar, nitrogen inlet adapter, thermometer and addition funnel with a nitrogen outlet adapter was placed 258 grams of the previously synthesized 1,10-bis(dimethylsilyl)decane. Two drops of a xylenes solution of platinum(divinyltetramethyidisiloxane) (United Chemical Technologies, Bristol, Pa.) were dissolved in one milliliter xylene and added to the flask. Then 496.1 grams of the trimethylsilyl-protected 10-undecen-1-ol was placed in the additional funnel. The nitrogen purge and stirring were initiated. The reaction was heated to 50° C. and then the heating mantle was turned off for the addition. The protected alcohol was added dropwise over forty minutes. The mixture was cloudy, possibly indicating that separate phases were present, and the temperature at the end of the addition was 44° C. The heating was continued and the reaction mixture cleared at about 62-65° C. The reaction mixture then exhibited a mild exotherm and the heating mantle was again turned off. The exotherm peaked at 93° C. about 25 minutes after the reaction mixture cleared. The reaction was then further heated, and monitored using infrared spectroscopy. Two hours later, three more drops of catalyst were added, and the reaction was stirred at 100° C. overnight. The next morning, the IR of the reaction mixture showed that the reaction had not gone to completion, and its GC suggested that the double bond of a small amount of the protected alcohol had isomerized to the corresponding cis- and trans-9-undecenyl compound. This is a known side reaction of hydrosilylation reactions, and the reaction of the remaining silanes was driven to completion by heating the reaction mixture to 100° C., adding five drops of catalyst to the reaction mixture, and then adding a further 100 grams of the protected alcohol dropwise. Twenty four hours later, the silane groups had almost entirely reacted by IR. The crude product was dissolved in two liters of hexanes and filtered through a column containing 20 cm of neutral alumina and 15 cm finely ground AMBERLITE IRC-718 ion exchange resin to remove the catalyst. The receiver attached to the column was placed under water aspirator vacuum to speed the filtration, and the hexanes removed using a rotary evaporator. The excess protected undecenol and side products were removed from a portion of the crude product by passage through a falling film evaporator at oil pump vacuum. Refluxing dodecane was used in the hot finger of the evaporator. The nonvolatile fraction (395 grams) had no silane remaining by IR. The diol was deprotected in two batches by stirring each batch overnight at room temperature in a solution of 700 milliliters ethanol, 35 milliliters water, and one drop concentrated hydrochloric acid. The batches were combined and the structure of the product confirmed using GPC, IR, and NMR.

### Example 4

Polyurethane Synthesis Using the Disilane Diol

A two-step solution polymerization process was used to make a polyurethane polymer containing the disilane diol of Example 3 as the soft segment. In a nitrogen-purged glovebox, 36.09 grams (0.1127 equivalent) of the disilane diol was added to a flame-dried, one-liter flask. The diol was blended with 300 grams of anhydrous dimethylacetamide. After heating to 90° C., 19.23 grams (0.2299 equivalent) of hexamethylene diisocyanate (DESMODUR H D240, Miles Laboratories, Pittsburgh, Pa.) was added. After 30 minutes, about 0.006 gram of dibutyltin dilaurate catalyst was added. The exotherm of the reaction increased the pot temperature to 98° C. To the resultant isocyanate-terminated prepolymer, 5.05 grams (0.1127 equivalent) of 1,4-butanediol (Mitsubishi Chemical America, Inc., White Plains, N.Y.) was added. After 30 minutes, no residual isocyanate was detected by infrared analysis. Four additions of 2 equivalent percent of hexamethylenediisocyanate (1.52 grams, 0.0182 equivalent in total) was required before a small peak of residual isocyanate was detected by infrared analysis. It is believed that the excess hexamethylenediisocyanate required is at least partially caused by amine impurities found in the dimethylacetamide solvent. The clear, low viscosity solution was precipitated from solution by addition to methanol while stirring in a 1.2-liter vessel attached to an explosion-proof, variable-speed laboratory blender. After filtering out the white powdered resin, the polymer was returned to the blender vessel and stirred with fresh methanol and filtered two additional times in an attempt to selectively remove the dimethylacetamide polymerization solvent. After drying in a vacuum oven at 50° C. for 72 hours, the polymer was molded into 0.635 millimeter (mm, 25 mil) films with a Carver press at 165° C. After cutting the clear, molded films into ASTM D638-5 test specimens, mechanical properties were obtained with a MTS Sintech I/D with extensometer. Results were Ultimate Tensile Strength (UTS)=20.9 Megapascals (MPa, 3031 pounds per square inch (psi)), Elongation=318% and Young's Modulus=65.4 MPa (9489 psi). Split tear specimens were also cut from the film with ASTM D624, Die B cutter. The tear strength was 108.6 kilonewtons per meter (kN/m) (620 pounds per linear inch). Gel Permeation Chromatography (GPC) was used to determine molecular weights with dimethylacetamide carrier solvent and polystyrene standards. Results were: Mw (weight average molecular weight)=40,600, Mn (number average molecular weight)=25,600, polydispersivity=1.64.

### Example 5

Synthesis of a Polyurethane Using a Two Step Method

A polymer containing a disilane diol was synthesized using a two-step polymerization process in solvent. Under anhydrous conditions, 37.50 grams (0.1171 equivalent) of a disilane diol were added to a one-liter round-bottomed flask. After addition of 300 grams of anhydrous dimethylacetamide the flask contents were heated to 90° C. At that time, 4.91 grams (0.0586 equivalent) of hexamethylenediisocyanate (DESMODUR H D240, Miles Laboratories) was added dropwise over a period of 15 minutes. After forty minutes at 90° C., about 0.006 gram of dibutyltin dilaurate was added. The exotherm of the reaction caused the pot temperature to increase to 98° C. Thirty minutes later, infrared analysis verified all isocyanate had reacted. To the resultant prepolymer, 2.66 grams (0.0585 equivalent) of 1,4-butanediol (Mitsubishi Chemical, America, Inc., White Plains, N.Y.) was added followed by 14.99 grams (0.1194 equivalent) of solid, flaked MDI (fused MONDUR M, Bayer Corporation, Pittsburgh, Pa.). The exotherm of the reaction increased the pot temperature from 90° C. to 95° C. After 15 minutes, infrared analysis indicated that all available isocyanate had reacted. In order to complete the reaction so as to produce a polymer with a theoretical isocyanate/hydroxyl ratio of about 1.01/1.00, four separate additions of 0.38 gram of MDI were required. The course of the reaction for each addition was monitored by infrared analysis by observing the absence or presence of an isocyanate absorbance at 2272 cm⁻¹. It is believed that the excess isocyanate needed was at least partially caused by side reactions with impurities in the dimethylacetamide polymerization solvent.

The resultant polymer was precipitated from solution by adding it to methanol contained in a 1.2-liter vessel as it was constantly stirred with an explosion-proof laboratory blender. After filtering the white, precipitated polymer from the solvent, the polymer was returned to the blender vessel and stirred with fresh methanol and filtered two additional times to selectively remove the majority of the polymerization solvent. After drying the polymer in a vacuum oven for 72 hours at 50° C., a Carver press was used to mold the polymer into two 0.635 mm (25 mil) thick films at 165° C. ASTM D638-5 tensile specimens were cut from the film for mechanical properties obtained with a Sintech I/D extensometer. Mechanical properties for ASTM D638-5 test specimens determined Ultimate Tensile Strength=25.9 MPa (3750 psi), Elongation=310%, Young's Modulus=70.3 MPa (10,200 psi). Molecular weight was analyzed by Gel Permeation Chromatography using dimethylacetamide solvent and polystyrene standards. Results were Mw=47,000, Mn=29,100, polydispersivity=1.62.

In vitro tests of oxidative and hydrolytic stability were then conducted on the polymer of Example 5. In addition, control samples of a commercially available polyurethane elastomer with a polytetramethylene ether glycol soft segment (PELLETHANE 80A) and MED 4719 silicone elastomer (Shore Hardness=60A, obtained from Nusil Silicone Technology of Carpinteria, Calif.) were used for comparison purposes. In vitro test solutions were 1.0N (Normal) sodium hydroxide and 1.0N ferric chloride. ASTM D638-5 test specimens were cut from films pressed as described above. Test specimens were placed in glass jars filled with 100 milliliters of the selected in vitro test solutions. The sealed jars were placed in a 70° C. oven for eight weeks. Additional test specimens were stored at ambient laboratory conditions for eight weeks. After 8 weeks, tensile properties of the test specimens were determined using a Sintech 1/D with extensometer with a crosshead speed of 12.7 cm per minute using a 22.67-kilogram (kg) (50-pound) load cell. Five specimens at each condition were tested. The values reported in Table 1 are the average of these specimens.

In Table 1 below, “8 weeks, RT air” refers to samples stored at ambient laboratory conditions (e.g., room temperature) for eight weeks; “8 weeks, wet” refers to samples stored in the respective test solution for eight weeks at 70° C., rinsed with deionized water, blotted dry, and tested immediately; “8 weeks, dried” refers to samples stored in the respective test solution for eight weeks at 70° C., rinsed with deionized water, and dried in a vacuum oven at 37° C. Also, “UTS” means ultimate tensile strength, reported in megapascals, “% E” means percent elongation before break, and “Young's Mod.” refers to Young's Modulus, also reported in megapascals. In the section of the Table labeled “percent retained”, the values of the specimens soaked in the solutions have been divided by the values for the specimens stored at ambient conditions and converted to percentage. This provides a gauge of how well the polymer specimens withstand the test conditions based on their original mechanical properties.

TABLE 1
In-vitro Chemical Stability Study

| Polymer of Example 5 | | | | Percent Retained | | |
|---|---|---|---|---|---|---|
| | UTS | | Young's Mod. | | | Young's |
| | MPa | % E | MPa | UTS | % E | Mod. (MPa) |
| 1.0 N NaOH | | | | | | |
| 8 weeks, RT | 25.9 | 309 | 70.2 | | | |
| air | | | | | | |
| 8 weeks, wet | 22.7 | 265 | 45.9 | 88 | 86 | 65 |
| 8 weeks, | 24.9 | 304 | 41.4 | 104 | 98 | 59 |
| dried | | | | | | |
| 1.0 M FeCl₃ | | | | | | |
| 8 weeks, RT | 25.9 | 309 | 70.2 | | | |
| air | | | | | | |
| 8 weeks, wet | 22.6 | 307 | 43.3 | 87 | 99 | 63 |
| 8 weeks, | 25.0 | 272 | 42.7 | 96 | 88 | 61 |
| dried | | | | | | |
| PELLATHANE 80A | | | | Percent Retained | | |
| | UTS | | Young's Mod. | | | Young's |
| | MPa | % E | MPa | UTS | % E | Mod. (MPa) |
| 1.0 N NaOH | | | | | | |
| 8 weeks, RT | 63.3 | 698 | 21.8 | | | |
| air | | | | | | |
| 8 weeks, wet | 51.0 | 837 | 16.2 | 81 | 120 | 75 |
| 8 weeks, | 67.3 | 698 | 20.8 | 107 | 100 | 96 |
| dried | | | | | | |
| 1.0 M FeCl₃ | | | | | | |
| 8 weeks, RT | 63.3 | 698 | 21.8 | | | |
| air | | | | | | |
| 8 weeks, wet | 30.4 | 707 | 16.1 | 48 | 101 | 74 |
| 8 weeks, | 45.5 | 654 | 22.3 | 72 | 94 | 103 |
| dried | | | | | | |
| MED 4719 Silicone Elastomer | | | | Percent Retained | | |
| | UTS | | Young's Mod. | | | Young's |
| | MPa | % E | MPa | UTS | % E | Mod. (MPa) |
| 1.0 N NaOH | | | | | | |
| 8 weeks, RT | 9.21 | 532 | 7.36 | | | |
| air | | | | | | |
| 8 weeks, wet | 9.87 | 608 | 6.19 | 107 | 114 | 84 |
| 8 weeks, | 11.6 | 354 | 7.35 | 126 | 68 | 100 |
| dried | | | | | | |
| 1.0 M FeCl₃ | | | | | | |
| 8 weeks, RT | 9.21 | 532 | 7.36 | | | |
| air | | | | | | |
| 8 weeks, wet | 3.08 | 224 | 5.12 | 33 | 42 | 70 |
| 8 weeks, | 3.80 | 233 | 5.52 | 38 | 44 | 75 |
| dried | | | | | | |

It can be seen from this data that the polyurethane of Example 5 demonstrates greater resistance to oxidation in the ferric chloride solution than PELLATHANE 80A. This may be seen by comparing the ultimate tensile strength of the two polymers. While the polymer of Example 5 retains 87% (wet) and 96% (dried) of its ultimate tensile strength, PELLETHANE 80A retains only 48% (wet) and 72% (dried) of its ultimate tensile strength. Ferric chloride is an oxidant, so this test demonstrates the superior oxidative resistance of the polymer of Example 5. This superior performance is even more striking considering that the PELLETHANE 80A used as a control contains antioxidants and has higher molecular weight.

The silicone elastomer test data also demonstrates that the polyurethane of Example 5 had a greater resistance to oxidation in ferric chloride solution than the silicone elastomer, Nusil MED 4719. While the polymer of Example 5 retained 87% (wet) and 96% (dried), Nusil MED 4719 retained only 33% (wet) and 38% (dried) of its ultimate tensile strength.

### Example 6

Synthesis of 7,7-Diethyl-7-silyl-1,12-tridecadiene

One hundred grams of 1,5-hexadiene was placed in a 500-milliliter round-bottomed three-neck flask. The flask was outfitted with a magnetic stirbar, heating mantle, water-cooled condenser, thermocouple, and addition funnel. The flask was heated with stirring. Meanwhile, the addition funnel was charged with 25 milliliters diethylsilane and 200 grams 1,5-hexadiene. Two milliliters of a platinum-divinyltetramethyldisiloxane complex in xylene (2-3% Pt) was added to the flask (United Chemical Technologies, Bristol, Pa.). The mixture in the addition funnel was added dropwise when the contents of the flask reached 40° C. A small exotherm was observed. After the addition was complete, the mixture was stirred overnight at 40° C. The reaction mixture was then transferred to a one-liter single-neck round-bottomed flask and the excess 1,5-hexadiene was removed using a rotary evaporator. The contents of the flask were then diluted with five volumes of hexanes and dried AMBERLITE IRC-718 ion exchange resin beads were added to sequester the platinum. The reaction mixture was then further purified by passage through a 1.5-cm diameter chromatography column to which had been added about 15 cm of silica gel, followed by 15 cm of activated neutral alumina. Additional hexane was used to elute the product, until a sample of eluent evaporated on a watchglass left no residue.

### Example 7

Synthesis of a Hydroxytelechelic Polycarbosilane Containing Diethylsilyl Groups

Step One: Metathetic polymerization of 7,7-diethyl-7-silyl-1,12-tridecadiene. The 7,7-diethyl-7-silyl-1,12-tridecadiene was distilled under vacuum and distillation cuts that were over 99% pure by gas chromatography were used. A magnetic stirbar and 100.3 grams (g) of 7,7-diethyl-7-silyl-1,12-tridecadiene were added to a one-liter round-bottomed single-neck flask. The monomer was sparged with nitrogen for 30 minutes. The flask was then transferred to an argon-atmosphere glovebox. Grubbs' imidazolium ruthenium metathesis catalyst (0.75 g) was added to the flask. The flask was then connected to a vacuum line. A valve in the vacuum line was opened just enough to induce rapid bubbling of the reaction solution. The pressure stabilized at 480 Pa (3.6 torr) with rapid bubbling. The reaction continued at the ambient glovebox temperature, 33° C. After 68 hours, the solution was brown in color and viscous. Bubbles were still forming and the pressure had decreased to 40 Pa (300 mtorr). The valve on the vacuum line was then opened all the way, and the pressure dropped to 7 Pa (54 mtorr). A diffusion pump was then opened to the system. After 71.5 hours at 33° C., a heating mantle was added and the temperature was increased to 50° C. With the increase in temperature, larger bubbles formed and the pressure increased to 17 Pa (128 mtorr). After 28 hours at 50° C., the reaction temperature was increased to 60° C. The reaction was allowed to continue for six days, at which point the polymer was very viscous and difficult to stir. Bubbles were still forming and the pressure was 3.2 Pa (24 mtorr). The reaction was terminated and the flask was removed from the glovebox. On weighing the flask, it was determined that no monomer was lost due to the reduced pressure.

The polymer was diluted with 250 milliliters (mL) hexanes to reduce the viscosity. Next, 27.8 g AMBERLITE IRC-718 ion exchange resin was added and the mixture was stirred for eighteen hours. The AMBERLITE IRC-718 was then filtered using a Buechner funnel with Number 40 Whatman filter paper. Hexanes were used to rinse the ion exchange resin and the filter flask, and the polymer was transferred back to the 1-Liter round-bottomed flask. The solution was still brown in color, and 40 additional grams of AMBERLITE IRC-718 ion exchange resin was added. This mixture was stirred for two hours and the ion exchange resin was then filtered through a Number 2 Whatman filter paper in a Buechner funnel. The color of the solution was then brownish-gray. The solution was eluted through a 3 cm diameter column containing 4 cm silica gel and 3 cm alumina activated (neutral). Hexanes were used as the eluent. The silica gel turned dark brown and the alumina remained white. The eluted solution was clear and colorless. The hexanes were removed by rotary-evaporation. A clear, colorless, viscous polymer resulted. The yield was 84.67 g of polymer, corresponding to an 84.7% yield.

The molecular weight of the polymer was estimated to be 36,000 grams per mole (g/mol), based on the proton NMR spectrum. The peaks observed by proton NMR were: δ6.05-5.95 (multiplet (m)), 5.85-5.75 (m), 5.6-5.1 (m), 5.05-4.9 (m), 2.1-1.9, 1.65, 1.45-1.2 (m), 1.0-0.8 (m), 0.7-0.4 (m). The absorbances observed by FTIR were: 2951.7, 2873.8, 2852.6, 1457.1, 1414.9, 1377.4,1340.2, 1235.7, 1169.2, 1013.8, 965.0, 850.7, 753.8, 720.4 cm⁻¹.

Step Two: Synthesis of an unsaturated acetoxytelechelic polycarbosilane using 1,20-diacetoxyeicosa-10-ene as the chain transfer agent. A chromatography column with an outside diameter of 18 cm (7.6 inches) containing 15 cm activated neutral alumina was connected to a twelve-liter single-neck round-bottomed flask using an adapter with a vacuum adapter. The 10-undecen-1-yl acetate was purified by passage through the column directly into the flask with vacuum applied through the adapter. The flask was weighed to find that 4.82 kg had been transferred to it. The flask was placed in a heating mantle on a magnetic stirring plate. A magnetic stir bar was added to the flask, and a sparge tube attached to a ground glass joint was fitted to it. The stirred monomer was sparged for twenty hours, then 10.93 g of bis(tricyclohexylphosphine)benzylideneruthenium(IV) dichloride (from Strem) was added to the flask and the neck quickly capped with a 20 cm Vigreux column connected to a vacuum line through an adapter. The vacuum line comprised an oil pump and a diffusion pump. Vacuum was immediately applied, and after 45 minutes, the pressure inside the flask had dropped sufficiently that the diffusion pump could be opened to the system, which reduced the pressure inside the flask to 1.33 Pa, and further dropped to 0.67 Pa five hours after the start of the reaction. Six hours after the catalyst was added, the reaction started to solidify, and gentle heat was applied to keep the reaction a stirrable slurry. An hour after heating was initiated, the temperature measure by a thermocouple placed between the flask and the mantle was 47.2° C. The variac controlling the heating mantle was turned down slightly at this point. The cold trap in the vacuum line had to be emptied every few hours to remove the condensed ethylene. Ten hours after the reaction was started, the temperature was 38° C., and after a further 15 hours, was 41.5° C. At this time, the variac was again turned down slightly. The reaction mixture at this time was an intense burgundy-colored liquid (except where mixture thrown against the wall of the flask above the mantle had solidified) and the pressure inside the flask was 0.4 Pa. By measuring the volume of liquid ethylene collected, the reaction was estimated to be 75% complete at this point. The reaction was continued for 7 days, with the temperature measured between the flask and mantle maintained at 43-44° C. At this point, the variac was turned up and the temperature equilibrated at 55.7° C. After 12 hours, the variac was again turned up, and the temperature equilibrated at 63.5° C. After twelve hours at this final temperature, the reaction was terminated, the flask backfilled with nitrogen, and ten grams of IRGANOX 1010 was added. The reaction mixture was diluted 1:1 with hexanes and maintained under nitrogen. Then 480 g of AMBERLITE IRC-718 ion exchange resin (washed with deionized water and dried under vacuum) was added to the flask and an air-driven mechanical stirrer was used to stir the reaction overnight. The next day, a chromatography column 76 cm long and 7.6 cm in diameter was filled consecutively with 5 cm sand, 20 cm activated neutral alumina, 5 cm AMBERLITE resin (ground in a ball mill), and 5 cm sand. The column was attached to a three-neck 12-liter round-bottomed flask. Vacuum from a water aspirator was attached to the flask through an adapter. The solution was pumped into the column using a peristaltic pump. The filtered solution was pale amber. The residue in the reaction flask was washed with several portions of hexanes, which was also pumped into the column. The column was further eluted with hexanes until no appreciable product remained on the column. The solution was placed in a freezer overnight, where it became a solid crystalline mass. After standing at room temperature for 24 hours, there was a large lump of white crystals in a pale amber solution. The liquid was pumped from the flask and the white crystals were washed twice with one liter portions of hexanes, with the liquid from these washings also pumped from the flask. Then hexanes were added to the flask to give a total volume of about eleven liters and the flask was heated to dissolve the crystals. The resulting solution was much paler in color than the initial hexanes solution. It was allowed to stand overnight at room temperature, but no crystals precipitated. It was then put in a freezer overnight, which resulted in a solid mass. After standing at room temperature for about two hours, the massed had thawed sufficiently that it could be filtered in two portions using a paper filter in a large Buechner funnel. Each portion of crystals was washed with 500 mL of room-temperature hexanes. The crystals were placed in a PYREX dish and then placed under vacuum overnight to remove the remaining hexanes. A total of 640 g of white crystalline product was isolated (the remaining product of the reaction was also isolated and reserved for other uses). The product was recrystallized from hexanes before use. As expected, twelve peaks were observed by ¹³C NMR: δ171.3, 130.4, 64.7, 31.2, 29.7, 29.5, 29.4, 29.3, 29.1, 28.6, 25.9, 20.3 parts per million (ppm). The peaks observed by proton NMR were: δ5.3 (triplet (t)), 4.0 (t), 2.1 (singlet (s)), 1.9 (m), 1.5 (m), 1.2 (m).

Step Three: In a one-liter round-bottomed flask, the 84.67 g of polysilane was sparged with nitrogen for 3 hours to remove all oxygen. The 1,20-diacetoxyeicosa-10-ene was dried in a vacuum oven for 3 hours. The reagents were then transferred to an Argon atmosphere glovebox and 39.37 g of 1,20-diacetoxyeicosa-10-ene was added to the polysilane. The temperature was increased to 60° C. and the mixture was magnetically stirred. The mixture became a homogeneous solution after 45 minutes, at which point 0.2 g of Grubbs' imidazolium ruthenium metathesis catalyst was added. Vacuum was applied and the solution bubbled vigorously. The temperature was maintained at 60° C. After one hour, the solution color had changed from pink to orange. After 65 hours, the solution was brown, less viscous, and no bubbles were observed. The flask was removed from the glovebox and 250 mL hexanes and 40 g dried AMBERLITE IRC-178 ion exchange resin were added. The mixture was stirred for 1.5 hours, until the solution color was light orange, and then filtered using a Buechner funnel and Number 2 Whatman paper. The solution was passed through 2 cm activated alumina and 4 cm silica gel in a 3 cm diameter column. Hexanes were used as the eluent, and the hexanes was subsequently removed by rotary-evaporation. The yield was 113.25 g of a pale yellow liquid. This was diluted in 250 mL hexanes and passed through a 3 cm diameter column containing 4 cm of silica gel. The hexanes were again removed by rotary-evaporation. The product remained pale yellow in color, and 105.81 g were collected.

The molecular weight of the acetoxytelechelic polycarbosilane was estimated to be 1050 g/mol, based on the proton NMR spectrum. The peaks observed by proton NMR were: δ5.3, 4.0 (t), 2.0, 1.6, 1.4−1.2, 0.9, 0.5 ppm. The absorbances observed by FTIR were: 2874, 2853, 1744, 1458, 1414, 1377, 1237, 1168, 1014, 965, 851, 753, 720 cm⁻¹.

Step Four: Deprotection of the hydroxyl groups. A 50% NaOH solution was made by dissolving 80.52 g NaOH in 80.64 g water. This solution was added to the one-liter round-bottomed flask containing the 105.81 g acetoxytelechelic polymer from Step Three, followed by 175 mL hexanes and 8.11 g ALIQUOT 336. The flask was outfitted with a condenser. The top of the condenser was connected to a source of nitrogen gas, with an outlet to a bubbler. The solution was magnetically stirred at high speed to mix the two phases and brought to reflux. After eighteen hours, a white emulsion was present in the flask. A sample was taken for FTIR analysis. The acetoxy peak at 1744 cm⁻¹ was completely absent, and a broad hydroxyl peak at 3330 cm⁻¹ had formed, indicating the deprotection was complete. The two-phase solution was then transferred to a 1000 mL separatory funnel. Adding chloroform effectively broke the emulsion and made the organic and aqueous layers clearly distinguishable. The aqueous phase was removed, and the remaining organic phase was rinsed several times with deionized water, until the aqueous wash had a neutral pH. A total of 6.5 liters of deionized water was used before a neutral pH was achieved. The organic phase was transferred to a 100-mL Erlenmeyer flask and dried with anhydrous magnesium sulfate. The organic phase was then filtered using a Buechner funnel with Number 2 Whatman filter paper. The hexanes and chloroform were removed by rotary-evaporation. The result was an unsaturated hydroxytelechelic polycarbosilane containing diethylsilyl groups. The polymer was a viscous, pale yellow liquid and 100.42 g were isolated.

The peaks observed by proton NMR were: δ5.3, 3.6 (t), 3.3, 3.2, 2.0, 1.5, 1.5−1.2, 1.2, 0.9, 0.5 ppm. The absorbances observed by FTIR were: 3330, 2874, 2853, 1457, 1415, 1377, 1340, 1237, 1168, 1057, 1014, 965, 851, 753, 720 cm⁻¹.

Step Five: Hydrogenation of the unsaturated hydroxytelechelic polycarbosilane containing diethylsilyl groups. The polymer produced in Step Four was divided (60 g/40 g) at this point to be hydrogenated by two different methods. A five-liter 3-neck round-bottomed flask, containing 60.4 g of the unsaturated diol, was equipped with a condenser, a stirrer driven by an airmotor, thermocouple, and a heating mantle connected to a temperature controller. The top of the condenser was outfitted with an inlet for the nitrogen purge and an outlet to a bubbler.

One liter of xylenes was added to the flask, followed by 60.0 g p-toluenesulfonhydrazide, 72 mL tributylamine, and 1400 mL xylenes. The cloudy white solution was mechanically stirred and slowly heated to 133° C. When the temperature reached 80° C., the solution became clear with a slight yellow tint. At 133° C., small bubbles formed, indicating nitrogen gas was being released as hydrogenation proceeded. After 15.5 hours, the solution was dark orange-brown in color. The reaction was monitored by taking aliquots for NMR analysis. Each aliquot was rinsed with water and a sample of the organic layer was used for analysis. The diol was 60% hydrogenated at this point. After 3 hours, the temperature of the reaction was increased to 137° C. and it was held at this temperature for 20 hours. The diol was then 70% hydrogenated. The solution was allowed to cool to 40° C., at which point an additional 30 g p-toluenesulfonhydrazide and 35 g tributylamine were added. The solution was heated to 136.5° C., and bubbling was observed. After eighteen hours, the solution was no longer bubbling and no signal due to alkenes was detected by NMR. The solution was transferred to a six-liter separatory funnel and rinsed with three portions of 800 mL deionized water. The organic layer was transferred to a 4-liter Erlenmeyer flask and dried using anhydrous magnesium sulfate. The magnesium sulfate was filtered using a Buechner funnel with Number 2 Whatman filter paper. Some of the solvents were removed by rotary-evaporation to reduce the volume. The solution was passed through a 3 cm diameter column containing 5 cm of neutral activated aluminum oxide. Xylenes were used as the eluent. The remaining solvent was then removed by rotary-evaporation. The diol was yellow in color. The yellow color was extracted using acetone. The resulting diol was viscous and cloudy white in color, and 21.98 g were collected. The NMR of the purified diol showed that 4% of the double bonds remained.

Both polymer samples were hydrogenated separately in a Parr pressure reactor. The hydrogenation was run for one week at 4.14 MPa and 60° C. using 10% Pd/C as catalyst to obtain the fully hydrogenated hydroxytelechelic polycarbosilane. The samples were dissolved in toluene sufficient to obtain a 10% solids solution.

The resulting hydrogenated diol (18.7 g) was characterized by NMR and FTIR. The peaks observed by proton NMR were: δ3.61, 1.45 (m), 1.4-1.1, 0.9 (t), and 0.055-0.40 ppm. The absorbances observed in the FTIR spectrum were: 3329, 2921, 2873, 2852, 1463, 1339, 1377, 1306, 1235, 1179, 1057, 755, and 717 cm⁻¹.

### Example 8

Synthesis of a Polyurethane Using the Diol of Example 7

A 250-milliliter three-neck round-bottomed flask was placed in a nitrogen-atmosphere glovebox and outfitted with stopper, thermocouple well adapter, magnetic stirbar, and condenser. The flask was outfitted with a heating mantle and placed on a magnetic stirring plate. To this flask was added 7.31 grams of the hydroxytelechelic polycarbosilane synthesized in Example 7 and 90 grams of anhydrous dioxane. The stirred solution was hazy, and 22.5 grams of anhydrous tetrahydrofuran were added to obtain an almost clear solution. Next, 2.18 grams of 4,4′-methylenebis(phenyl isocyanate) were added and the solution heated to 50° C. Once the solution had reached the desired temperature, one drop of dibutyltin dilaurate (approximately 0.005 g) was added. No exotherm was observed. Then 0.36 g 1,4-butanediol was added, corresponding to 70% of the 1,4-butanediol required as suggested by nuclear magnetic resonance analysis of the hydroxytelechelic polycarbosilane. Fifty minutes after this addition, a drop of the solution was evaporated on a KBr infrared (IR) plate and the IR of the polymer taken. This IR showed a large band due to isocyanate, as would be expected. Additional 1,4-butanediol portions of 0.09 g, 0.06 g, and 0.03 g were sequentially added at about 45 minute intervals. The total amount of 1,4-butanediol added corresponded to the amount required based on the estimated hydroxytelechelic polycarbosilane molecular weight. The effect of these additions was monitored using IR and after the third addition resulted in a very weak band in the infrared spectrum due to residual isocyanate, suggesting that 1-2% of the isocyanate remained unreacted. The solution was poured into 500 mL reagent grade ethanol stirred in a laboratory blender, yielding a fine, white precipitate. The precipitate was isolated by filtering the mixture using Number 41 Whatman filter paper in a Buechner funnel using water aspirator vacuum. The polymer precipitate was then washed by stirring it in an additional 500 mL of reagent grade ethanol in a laboratory blender, and refiltered as described above. The isolated precipitate was dried for approximately 60 hours in a vacuum oven at 50° C. The final yield of dried polymer was 8.83 grams. A 0.254-mm film was pressed and five ASTM D638-5 test specimens were cut from it. The remainder of the polymer sample was redried in a 50° C. vacuum oven. This film was pressed into a 0.635 mm film and six ASTM D638-5 test specimens were cut from it. Tensile properties of the test specimens were determined using a MTS Sintech 1/D tensile tester with extensometer with a crosshead speed of 1.27 cm per minute using a 45.5 kg (100 pound) load cell. The properties found were: ultimate tensile strength 5.46 MPa, elongation at break 39.3%, and Young's Modulus 19.9 MPa. The absorbances observed by FTIR were: 3329, 2922, 2852, 1704, 1597, 1534, 1464, 1414, 1311, 1234, 1080, 1016, 817, 718, and 510 cm⁻¹. Proton and carbon nuclear magnetic resonance spectra were obtained using a JEOL ECLIPSE 400 spectrometer in deuterated tetrahydrofuran. The peaks observed in the proton NMR spectrum were: δ10.83 (s), 8.59 (s), 8.54 (s), 7.36 (s), 7.34 (s), 7.04 (s), 7.01 (s), 4.1 (m), 3.6 (s), 2.49 (s), 1.29-1.32 (m), 0.92 (m), 0.52 (m) ppm. The peaks observed by ¹³C NMR: δ153.4, 128.9, 118.0, 66.7, 66.5, 66.3, 34.0, 24.8, 24.6, 24.4, 24.2, 24.0, 23.9, 11.6, 7.0, 3.57 ppm.

### Example 9

A High Molecular Weight Polymer Containing Silane Groups Synthesized Using a Hydrosilylation Route

Step One: Synthesis of a vinyldimethylsilyl-terminated alcohol in which a tetrahydropyranyl group protects the alcohol (Compound 1). A three-neck twelve-liter round-bottomed flask is outfitted with a stirrer connected to an air motor and a condenser. To the flask is added 1010 grams of 10-undecen-1-ol (Bedoukian Research, Inc., Danbury, Conn.) and 500 grams of 3,4-dihydro-2H-pyran. The mixture is stirred to mix the components and 2 g of p-toluenesulfonic acid monohydrate is added. Stirring is continued for four hours, until the exotherm is complete and the reaction has returned to room temperature. The catalyst is removed from the reaction mixture by filtration through a 10 cm bed of alumina in a chromatography column that is 5 cm in diameter.

Five hundred grams of the distilled product and 20 parts per million platinum-divinyltetramethyldisiloxane hydrosilylation catalyst are placed in a dry 12-liter four-neck round-bottomed flask outfitted with a heating mantle. A stirrer connected to an air motor is placed in the central neck of the flask. An efficient condenser is placed in one neck and connected to a source of cooling water. An adapter connected to a nitrogen source and bubbler is attached to the condenser. A thermocouple is placed in another neck of the flask. An addition funnel containing 190 grams dimethylchlorosilane is placed in the fourth neck. Stirring is initiated and the contents of the flask are heated to 40° C. The dimethylchlorosilane is added dropwise at such a rate as not to flood the condenser. After the addition is complete, stirring is continued with the temperature increased to 60° C. The reaction is monitored by IR and heating continued until all alkene has reacted. The heating is stopped, and the flask cooled to room temperature. Six liters of anhydrous tetrahydrofuran are added to the flask, followed by 1.25 liters of a 1.6 M (Molar) solution of vinylmagnesium chloride in tetrahydrofuran (Aldrich). After the addition is complete, the reaction is heated to reflux and maintained at reflux overnight. The reaction is then cooled to room temperature. Water is added cautiously to quench any unreacted vinylmagnesium chloride, and the solution is filtered to remove the precipitated salts. The solvent is removed using a rotary evaporator, and the crude product is fractionally distilled under vacuum.

Step Two: Synthesis of 1,6-Bis(vinyldimethylsilyl)hexane (Compound 2). Five hundred grams of 1,6-bis(chlorodimethylsilyl)hexane (Gelest, Inc., Morrisville, Pa.) is placed in a dry twelve-liter four-neck round-bottomed flask. The flask is outfitted with a stirrer connected to an air motor, a thermocouple, an addition funnel, and a condenser. An adapter connected to a nitrogen source and bubbler is attached to the condenser. Five liters of anhydrous tetrahydrofuran is added, followed by 2.32 liters of a 1.6 M solution of vinylmagnesium chloride in tetrahydrofuran. The reaction mixture is refluxed overnight, then cooled to room temperature. Water is added to quench any unreacted vinylmagnesium chloride. The solution is filtered to remove the precipitated salts, and the solvent removed using a rotary evaporator. The crude product is fractionally distilled under vacuum.

Step Three: Synthesis of 1,6-Bis(dimethylsilyl)hexane (Compound 3). Five hundred grams of 1,6-dichlorohexane and six liters of anhydrous tetrahydrofuran are placed in a dry twelve-liter round-bottomed flask outfitted with rubber septa. Then 175 grams of magnesium turnings are placed in a second dry twelve-liter four neck round-bottomed flask. The second flask is outfitted with a stirrer connected to an air motor, a septum, a thermocouple, and a condenser connected to a nitrogen bubbler. A sufficient amount of the 1,6-dichlorohexane solution is transferred under nitrogen pressure to the second flask to cover them. The contents of the flask are stirred and heated until the Grignard reaction initiates. The heating is stopped and the remaining 1,6-dichlorohexane solution is added slowly, so as to maintain the reaction mixture at gentle reflux. The reaction mixture is then heated to maintain reflux overnight. The contents of the flask are then cooled to room temperature, and 672 grams of dimethylchlorosilane are added dropwise to the flask. The mixture is refluxed for 24 hours. It is then cooled to room temperature and water is cautiously added to quench any remaining Grignard reagent. The precipitated salts are filtered, and the solvent removed using a rotary evaporator. The crude product is fractionally distilled under vacuum.

Step Four: Polymerization and Deprotection of the Polymer. Two moles of Compound 1 and one mole of Compound 2 are combined in a five-liter three-neck round-bottomed flask. Twenty parts per million platinum-divinyltetramethyldisiloxane hydrosilylation catalyst is added to the flask. Two moles of Compound 3 are placed in an addition funnel attached to the flask. The flask is outfitted with a stirrer connected to an air motor. The contents of the flask are stirred and heated to 60° C. Compound 3 is added to the flask at a rate such that the flask temperature does not exceed 100° C. The disappearance of the vinyl absorbance in the infrared spectrum is used to follow the progress of the reaction. When the reaction is complete by IR, the polymer is dissolved in methanol. Fifty grams of DOWEX-50W-X8 ion exchange resin is added and the reaction is stirred at room temperature for four hours to deprotect the polymer. The polymer solution is filtered to remove the ion exchange resin, and the methanol is removed using a rotary evaporator. The polymer is redissolved in four liters of ether and neutralized by washing with saturated aqueous sodium bicarbonate solution. The organic phase is then dried with anhydrous magnesium sulfate and filtered through a 10 cm plug of neutral alumina in a 5 cm diameter chromatography column. An additional liter of tetrahydrofuran is eluted through the alumina to remove any remaining polymer and combined with the polymer-tetrahydrofuran solution. The tetrahydrofuran is removed using a rotary evaporator.

Step Five: Incorporation into a Polyurethane. One hundred seventeen grams of the polymer synthesized according to Step Four is placed in a three-liter three-neck round-bottomed flask with 11.72 grams of 1,4-butanediol and three drops of dibutyltin dilaurate. One liter of anhydrous dioxane is added. The solution is stirred magnetically and heated to 50° C., then 58.5 grams of 4,4′-methylenebis(phenylisocyanate) (MDI) are added to the solution. The solution is stirred and monitored by IR until the IR spectra indicates that the hydroxyls have reacted and the isocyanate absorbance at about 2272 cm⁻¹ is at a constant value that experience has shown to be representative of about a 1.02/1.00 isocyanate to hydroxyl ratio. The reaction mixture is then cooled to room temperature. The polymer is precipitated by pouring the reaction mixture into cold, stirred acetone. The precipitated polymer is placed on a paper filter in a Buechner funnel and washed with additional cold acetone. The polymer is then placed on a glass tray in a vacuum oven and dried under vacuum overnight at 50° C.

### Example 10

Synthesis of a Diphenylsilane Monomer

One hundred grams of 1,5-hexadiene (Aldrich) was placed in a 500-milliliter round-bottomed three-neck flask. The flask was outfitted with a magnetic stirbar, heating mantle, water-cooled condenser, thermocouple, and addition funnel. The flask was heated with stirring. Meanwhile, the addition funnel was charged with 25 milliliters diphenylsilane and 200 grams 1,5-hexadiene. Two milliliters of a platinum-divinyltetramethyidisiloxane complex in xylene (2-3% Pt) was added to the flask (United Chemical Technologies, Bristol, Pa.). The mixture in the addition funnel was added dropwise when the contents of the flask reached 60° C. After the addition was complete, the mixture was stirred overnight at 60° C. The reaction mixture was then transferred to a one-liter single-neck round-bottomed flask and the excess 1,5-hexadiene was stripped off using a rotary evaporator. The contents of the flask were then diluted with five volumes of hexanes and dried AMBERLITE IRC-718 ion exchange resin beads were used to sequester the platinum. The reaction mixture was then further purified by passage through a 1.5-cm diameter chromatography column to which had been added about 15 cm of silica gel, followed by 15 cm of activated neutral alumina. Additional hexane was used to elute the product, until a sample of eluent evaporated on a watchglass left no residue.

### Example 11

Synthesis of an Unsaturated Polymer Containing Diphenylsilane Groups

A one-liter single-neck round-bottomed flask is outfitted with a magnetic stirbar and placed on a stirplate in a glovebox (with an argon atmosphere of less than 1 part per million moisture and oxygen). A heating mantle is placed under the flask and 95.7 grams of the diphenylsilane monomer synthesized in Example 10 and 42.4 grams of 10-undecen-1-yl acetate (Bedoukian Research Incorporated, Danbury, Conn.) are added to the flask. Stirring is initiated and 500 milligrams of Grubbs' imidazolium ruthenium metathesis catalyst is added. A 15-cm Vigreux column is placed on the flask, and a valved adapter connected to a vacuum line is then placed on the Vigreux column. The vacuum line comprises both a mechanical vacuum pump and an oil diffusion pump. The vacuum line adapter is opened to the greatest extent possible without the reaction mixture foaming out of the flask, and then further opened as the foaming subsides until it is completely open. After the foaming has subsided and full vacuum has been applied, the reaction mixture is gently heated until it reaches a temperature of 50° C. The reaction mixture is maintained in this state for three days, until the mixture becomes viscous and there are no bubbles generated. The heating is then halted and the flask is disconnected from the vacuum line and removed from the glovebox. The reaction mixture is diluted with four volumes of hexane, and 20 grams of dried AMBERLITE IRC-718 ion exchange resin beads are used to sequester the ruthenium. The ion exchange resin is then filtered from the solution using a Buechner funnel under water aspirator vacuum. The filtrate is then passed through a column containing silica gel and activated neutral alumina. Additional hexane is used to elute the column until no further polymer is recovered at the column tip. The eluted polymer in hexane is then placed in a one-liter single-neck round-bottomed flask and the hexane is stripped off the polymer using a rotary evaporator until it is at about the initial four to one ratio. A magnetic stirbar and 200 milliliters of a fifty weight percent solution of sodium hydroxide in water is then added to the flask and stirring is initiated. Ten grams of ALIQUOT-336 phase transfer catalyst (Aldrich) is added to the flask. The contents of the flask are stirred as rapidly as practical using a magnetic stirplate. The progress of the reaction is monitored using infrared spectroscopy, and when complete, the organic phase is washed with several portions of deionized water until a pH test paper indicates the wash water is neutral.

### Example 12

Hydrogenation of an Unsaturated Polymer

The polymer product of Example 11 is dissolved in four liters of toluene and placed in an 11.4 liter (three-gallon) Parr high-pressure vessel. Twenty grams of 10% palladium on activated carbon is added and the reactor is sealed. The vessel is charged with 3.45 MPa (500 psi) of ultra high purity hydrogen (grade 5), and the mixture stirred at 100 rpm and heated to 50° C. After five days, the vessel is cooled to room temperature and the pressure released. The reaction mixture is filtered through a short pad of silica gel (6 centimeters in a column with diameter of 10 centimeters) using a 3:1 mixture of toluene and ethyl acetate as the mobile phase to remove the catalyst. The solvents are removed using a rotary evaporator to yield the desired polymer.

### Example 13

Synthesis of a Disilane Monomer

One hundred grams of 1,5-hexadiene (Aldrich) are placed in a one-liter round-bottomed three-neck flask. The flask is outfitted with a magnetic stirbar, heating mantle, water-cooled condenser, thermocouple, and addition funnel. One hundred grams of the disilane Compound 3 (described in Step 3 of Example 9 and 400 grams of 1,5-hexadiene are placed in the addition funnel. Two milliliters of a platinum-divinyltetramethyldisiloxane complex in xylene (2-3% Pt) is added to the flask (United Chemical Technologies, Bristol, Pa.). The mixture in the addition funnel is added dropwise when the contents of the flask reaches 60° C. After the addition is complete, the mixture is stirred overnight at 60° C. The reaction mixture is then transferred to a one-liter single-neck round-bottomed flask and the excess 1,5-hexadiene is stripped off using a rotary evaporator. The contents of the flask are then diluted with five volumes of hexanes. The solution is stirred with dried AMBERLITE IRC-718 ion exchange resin beads to sequester the platinum. The reaction mixture is then further purified by passage through a 1.5-cm diameter chromatography column to which has been added about 15 cm of silica gel, followed by 15 cm of activated neutral alumina. Additional hexane is used to elute the product, until a sample of eluent evaporated on a watchglass leaves no residue.

The complete disclosures of the patents, patent documents, and publications cited herein are incorporated by reference in their entirety as if each were individually incorporated. Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

What is claimed is:

1. A segmented polymer comprising one or more soft segments comprising silane-containing groups, wherein the soft segments are derived from a compound of the formula:
HO—R¹—Si(R²)₂—[—R³—Si(R²)₂—]ₙ—R¹—OH
wherein:
n=1 or more;
each R¹ is independently a straight chain or branched alkylene group optionally including heteroatoms;
each R² is independently a saturated or unsaturated aliphatic group, an aromatic group, or combinations thereof, optionally including heteroatoms; and
each R³ is independently a straight chain alkylene group, a phenylene group, or a straight chain or branched alkyl substituted phenylene group, wherein each R³ optionally includes heteroatoms;
with the proviso that the polymer is substantially free of carbonate linkages.

2. The polymer of claim 1 which is substantially free of urea linkages.

3. The polymer of claim 1 wherein n=1 to 50.

4. The polymer of claim 1 wherein each R¹ is independently a straight chain or branched (C3-C20)alkylene group.

5. The polymer of claim 1 wherein each R² is independently an alkyl group, a phenyl group, or an alkyl substituted phenyl group.

6. The polymer of claim 5 wherein each R² is independently a straight chain or branched (C1-C20)alkyl group, a phenyl group, or a straight chain or branched (C1-C20)alkyl substituted phenyl group.

7. The polymer of claim 6 wherein each R² is independently a straight chain (C1-C3)alkyl group.

8. The polymer of claim 1 further comprising urethane groups.

9. The polymer of claim 1 wherein each R³ is independently a (C1-C20)alkylene group.

10. The polymer of claim 1 wherein each R³ is independently a (C4-C12)alkylene group.

11. The polymer of claim 10 wherein each R³ is independently a (C6-C10)alkylene group.

12. The polymer of claim 1 with the proviso that when R³ is an unsubstituted straight chain alkylene group it has more than 4 carbons.

13. The polymer of claim 1 which is a biomaterial.

14. The polymer of claim 1 which is substantially free of ether and ester linkages.

15. The polymer of claim 1 which is linear, branched, or crosslinked.

16. The polymer of claim 1 further comprising one or more soft segments derived from a diol that does not contain a silane-containing group.

17. The polymer of claim 1 further comprising one or more hard segments derived from a chain extender.

18. A medical device comprising a segmented polymer comprising one or more soft segments comprising silane-containing groups derived from a compound of the formula:
HO—R¹—Si(R²)₂—[—R³—Si(R²)₂—]ₙ—R¹—OH
wherein:
n=1 or more;
each R¹ is independently a straight chain or branched alkylene group optionally including heteroatoms;
each R² is independently a saturated or unsaturated aliphatic group, an aromatic group, or combinations thereof, optionally including heteroatoms; and
each R³ is independently a straight chain alkylene group, a phenylene group, or a straight chain or branched alkyl substituted phenylene group, wherein each R³ optionally includes heteroatoms;
with the proviso that the polymer is substantially free of carbonate linkages.

19. The medical device of claim 18 wherein the segmented polymer is substantially free of urea linkages.

20. The medical device of claim 18 wherein n=1 to 50.

21. The medical device of claim 18 wherein each R¹ is independently a straight chain or branched (C3-C20)alkylene group.

22. The medical device of claim 18 wherein each R² is independently an alkyl group, a phenyl group, or an alkyl substituted phenyl group.

23. The medical device of claim 22 wherein each R² is independently a straight chain or branched (C1-C20)alkyl group, a phenyl group, or a straight chain or branched (C1-C20)alkyl substituted phenyl group.

24. The medical device of claim 23 wherein each R² is independently a straight chain (C1-C3)alkyl group.

25. The medical device of claim 18 further comprising urethane groups.

26. The medical device of claim 18 wherein each R³ is independently a (C1-C20)alkylene group.

27. The medical device of claim 18 wherein each R³ is independently a (C4-C12)alkylene group.

28. The medical device of claim 27 wherein each R³ is independently a (C6-C10)alkylene group.

29. The medical device of claim 18 with the proviso that when R³ is an unsubstituted straight chain alkylene group it has more than 4 carbons.

30. The medical device of claim 18 wherein the polymer is a biomaterial.

31. The medical device of claim 18 wherein the polymer is substantially free of ether and ester linkages.

32. The medical device of claim 18 wherein the polymer is linear, branched, or crosslinked.

33. The medical device of claim 18 wherein the polymer further comprises one or more soft segments derived from a diol that does not contain a silane-containing moiety.

34. The medical device of claim 18 wherein the polymer further comprises one or more hard segments derived from a chain extender.

35. A segmented polymer comprising one or more soft segments comprising silane-containing groups of the formula:
—R¹—Si(R²)₂—[—R³—Si(R²)₂—]ₙ—R¹—
wherein:
n=1 or more;
each R¹ is independently a straight chain or branched alkylene group optionally including heteroatoms;
each R² is independently a saturated or unsaturated aliphatic group, an aromatic group, or combinations thereof, optionally including heteroatoms; and
each R³ is independently a straight chain alkylene group, a phenylene group, or a straight chain or branched alkyl substituted phenylene group, wherein each R³ optionally includes heteroatoms;
with the proviso that the polymer is substantially free of carbonate linkages.

36. The polymer of claim 35 comprising urethane groups.

37. A medical device comprising a segmented polymer comprising one or more soft segments comprising silane-containing groups of the formula:
—R¹—Si(R²)₂—[—R³—Si(R²)₂—]ₙ—R¹—
wherein:
n=1 or more;
each R¹ is independently a straight chain or branched alkylene group optionally including heteroatoms;
each R² is independently a saturated or unsaturated aliphatic group, an aromatic group, or combinations thereof, optionally including heteroatoms; and
each R³ is independently a straight chain alkylene group, a phenylene group, or a straight chain or branched alkyl substituted phenylene group, wherein each R³ optionally includes heteroatoms;
with the proviso that the polymer is substantially free of carbonate linkages.

38. The medical device of claim 37 wherein the segmented polymer comprises urethane groups.

39. A method of making a segmented polymer, the method comprising: combining a polyisocyanate with a compound of the formula:
HO—R¹—Si(R²)₂—[—R³—Si(R²)₂—]ₙ—R¹—OH
wherein:
n=1 or more;
each R¹ is independently a straight chain or branched alkylene group optionally including heteroatoms;
each R² is independently a saturated or unsaturated aliphatic group, an aromatic group, or combinations thereof, optionally including heteroatoms; and
each R³ is independently a straight chain alkylene group, a phenylene group, or a straight chain or branched alkyl substituted phenylene group, wherein each R³ optionally includes heteroatoms;
with the proviso that the polymer is substantially free of carbonate linkages.

40. The method of claim 39 wherein the segmented polymer comprises urethane groups.
